(19) United States
(12) Patent Application Publication
(10) Pub. No.: US 2017/0148029 A1
(43) Pub. Date: May 25, 2017

(54) PAYMENT VERIFICATION SYSTEM, METHOD AND APPARATUS

(71) Applicant: Xiaomi Inc., Beijing (CN)

(72) Inventors: Yang HU, Beijing (CN); Junqi Lin, Beijing (CN); Yuanyuan Huang, Beijing (CN)

(73) Assignee: Xiaomi Inc., Beijing (CN)

(21) Appl. No.: 15/218,428

(22) Filed: Jul. 25, 2016

(30) Foreign Application Priority Data
Nov. 23, 2015 (CN) 2015108188935

(51) Int. Cl. G06Q 20/40; G06Q 20/42; G06Q 20/38

(52) U.S. Cl. CPC G06Q 20/40145; G06Q 20/3829; G06Q 20/42

(57) ABSTRACT

The present disclosure is related to a payment verification system, method and apparatus, which pertain to the field of security technologies. The system includes a device verification server and at least one payment verification server. The device verification server is configured to register the at least one payment verification server to provide a payment service that is based on biometric recognition, and verify a user device in response to a request from the user device to activate a payment function for the user device that is based on biometric recognition. The payment verification server is configured to verify a payment application that is used on the user device in response to the request when the user device is verified with success, activate the payment function for the user device when the payment application is verified with success, and verify one or more payment requests from the user device.

This application claims priority of the Chinese Patent Application No. 201510818893.5, filed on Nov. 23, 2015, which is incorporated herein by reference in its entirety.

### FIELD

The present disclosure is related to the field of security technologies, and more particularly, to a payment verification system, method and apparatus.

### BACKGROUND

With development of security technologies, it becomes easier for users to use biological recognition, information such as fingerprints, irises and sounds. Payment behaviors using biological recognition information such as fingerprints are becoming popular.

From the aspect of software, the Android system is in an insecure environment. To solve the problem that common operating systems in cell phones are vulnerable to attack, device manufacturers divide cell phones into Trusted Execution Environment TEE and Rich Execution Environment REE at the hardware level. The Android system is stored in the REE in Android cell phones. Sensitive data is stored and processed in the TEE. By using this technology, key data is protected at the hardware level. For example, storage of fingerprint information and recognition of fingerprint images are performed in the TEE.

In the related arts, device manufacturers need to do the following three things to ensure identity verification of a party making a payment request: verifying that the request is sent from an authentic and trusted device; verifying that the request is sent from an authentic and trusted application; and verifying that the request is sent from an authentic and trusted user. The first two verification processes allow the provisioning of a payment function, and the last verification process ensures that a fingerprint payment function can be used normally.

During the performance of the above verification processes, if devices and users of the payment application increase in number remarkably, the servers at the device manufacturers' side will face a huge volume of simultaneous accesses, which is a challenge for the load capacity of the servers.

### SUMMARY

Aspects of the disclosure provide a system for payment verification that includes a device verification server and at least one payment verification server. The device verification server is configured to register the at least one payment verification server to provide a payment service that is based on biometric recognition, and verify a user device in response to a request from the user device to the at least one payment verification server to activate a payment function for the user device that is based on biometric recognition. The payment verification server is configured to verify a payment application that is used on the user device in response to the request from the user device to activate the payment function when the user device is verified with success, activate the payment function for the user device when the payment application is verified with success, and verify one or more payment requests from the user device.

According to an aspect of the disclosure, the device verification server is configured to store a device public key of the user device that pairs with a device private key of the user device and receive first signature information carried in a first message associated with the request from the user device to activate the payment function. The first signature information is generated based on the device private key of the user device. Then, the device verification server is configured to verify the first signature information using the device public key of the user device and when the verification of the first signature information is successful, send a verification success message to the payment verification server.

Further, in an example, the payment verification server is configured to store an application public key uploaded by the user device when the verification success message is received from the device verification server. The application pubic key is paired with an application private key of the user device. The payment verification server is configured to receive second signature information carried in a second message associated with the request from the user device to activate the payment function. The second message carries a user public key and the second signature information that is generated based on the application private key. Then the payment verification server is configured to verify the second signature information based on the application public key, and to store the user public key when the second signature information is verified with success.

Further, in an example, the payment verification server configured to receive third signature information carried in a third message associated with a payment request from the user device. The third signature information is generated based on a user private key that pairs with the user public key. Then the payment verification server is configured, to verity the third signature information based on the user public key of the user device and when the verification of the third signature information is successful, execute the payment request.

In an example, the system further includes a payment server configured to perform message transmission between the user device and the payment verification server.

Aspects of the disclosure provide a method for payment verification. The method includes registering at least one payment verification server on a device verification server to provide a payment service that is based on biometric recognition to users, verifying, by the device verification server, a user device in response to a request from the user device to the payment verification server to activate a payment function that is based on biometric recognition, verifying, by the payment verification server, a payment application that is used on the user device in response to the request from the user device when the user device is verified with success, activating, by the payment verification server, the payment function for the user device when the payment application is verified with success and verifying, by the payment verification server one or more payment requests from the user device.

To verify, by the device verification server, the user device in response to the request from the user device to the payment verification server to activate the payment function that is based on biometric recognition, in an example, the method includes storing, at the device verification server, a device public key of the user device that pairs with a device private key of the user device, and receiving, at the device verification server, first signature information carried in a first message associated with the request from the user device to activate the payment function. The first signature information is generated based on the device private key of the user device. Further, the method includes verifying, by the device verification server, the first signature information using the device public key of the user device and sending a verification success message to the payment verification server when the first signature information is verified with success.

According to an aspect of the disclosure, the method further includes storing, at the payment verification server, an application public key uploaded by the user device when the verification success message is received from the device verification server. The application public key is paired with an application private key of the user device. Then, the method includes receiving, at the payment verification server, second signature information carried in a second message associated with the request from the user device to activate the payment function. The second message carries a user public key and the second signature information that is generated based on the application private key. Then, the method includes verifying, by the payment verification server, the second signature information based on the application public key, and storing the user public key at the payment verification server when the second signature information is verified with success.

To verify, by the payment verification server one or more payment requests from the user device, in an example, the method includes receiving, at the payment verification server, third signature information carried in a third message associated with a payment request from the user device. The third signature information is generated based on a user private key that pairs with the user public key. Then, the method includes verifying the third signature information based on the user public key of the user device, and executing the payment request when the third signature information is verified with success. Further, in an example, the method includes transmitting, by a payment server, messages between the user device and the payment verification server.

Aspects of the disclosure provide a payment verification apparatus. The payment verification apparatus includes a processor and a memory storing an instruction executable by the processor. The processor is configured to receive a request from a user device to activate a payment function based on biometric recognition, and send the request to a device verification server for the device verification sever to verify the user device. The payment verification apparatus is registered on the device verification server to provide a payment service that is based on biometric recognition. Further, the processor is configured to verify a payment application that is used on the user device in response to the request when the user device is verified with success by the device verification server, activate the payment function for the user device when the payment application is verified with success and verify one or more payment requests from the user device.

It should be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a diagram showing an architecture of a payment verification system according to an exemplary embodiment;

FIG. 2 is a flow chart illustrating interactions in the architecture of the above payment verification system;

FIG. 3 is a flow chart showing a payment verification method according to an exemplary embodiment;

FIG. 4 is a block diagram of a payment verification apparatus according to an exemplary embodiment;

FIG. 5 is a block diagram of a payment verification apparatus 500 according to an exemplary embodiment.

### DETAILED DESCRIPTION

To make the objectives, technical solutions and advantages of this disclosure clearer, the embodiments of this disclosure in detail with reference to the accompanying drawings will be described in the following.

Reference will now be made in detail to exemplary embodiments, examples of which are illustrated in the accompanying drawings. The following description refers to the accompanying drawings in which the same numbers in different drawings represent the same or similar elements unless otherwise presented. The embodiments set forth in the following description of exemplary embodiments do not represent all embodiments consistent with the invention. Instead, they are merely examples of apparatuses and methods consistent with aspects related to the invention as recited in the appended claims.

TEE refers to a safe execution environment, and is also called “Secure World”.

REE refers to an unsafe execution environment, and is also called “Normal World or Non-Secure World”.

Trusted Operating System OS operates in the TEE, and operates in parallel with the Android system in a cell phone chip in an Android cell phone.

Client Application CA refers to an application operating the REE, and refers to the Android software itself when it operates in an Android cell phone.

System Trusted Application TA needs signature using a system key, and is pre-installed under a corresponding catalogue of a cell phone before the cell phone leaves a factory.

Service Provider Trusted Application SP TA refers to a TA developed by a third party that needs signature using an SP key and may be installed under a corresponding catalogue of a cell phone by downloading afterwards.

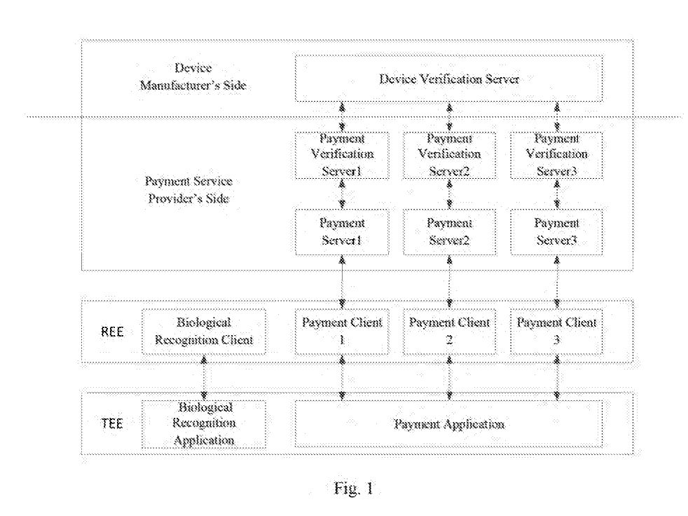

FIG. 1 is a diagram showing an architecture of a payment verification system according to an exemplary embodiment. As shown in FIG. 1, the system comprises a device verification server at a device manufacturers side and at least one payment verification server at a payment service provider's side.

The device verification server is configured to have a biological recognition information-based payment function (biometric recognition based payment function) registered thereon for the payment verification server, and the device verification server is also configured to, when a user device applies for provisioning of the payment function, verily the user device.

The biological recognition information may be fingerprint information, iris information, facial characteristics or voice characteristics, and may be used in various verification manners such as fingerprint recognition, iris recognition, human face recognition and human voice recognition, etc.

The payment verification server is configured to, when the user device applies for the provisioning of the payment function, verify a payment application operating on the user device if the verification of the user device by the device verification server is successful, and provision the payment function for the user device if the verification of the payment application is successful. The payment verification server is also configured to, upon receiving a payment request from the user device, verify the payment request.

One payment verification server may provide verification services to at least one payment application, which will not be specifically defined in the embodiments of this disclosure. The user device may send any of a payment request or a payment function provisioning request to a payment server corresponding to a payment application, and then the request is sent by the payment server to the payment verification server for verification. Of course, the payment verification server and the payment server may be two functional blocks in the same physical device or in different physical devices, which will not be specifically defined in the embodiments of this disclosure.

At the user device's side, the user device may operate a biological recognition client and a payment client etc. in the REE, operate a biological recognition TA corresponding to the biological recognition client at the TEE side, and operate corresponding payment TAs for multiple payment clients so as to perform verification processes with the payment service provider side via payment applications during the payment process. Of course, the user device may be provided with a sensor for collecting a user's biological recognition information or the like, which will not be specifically defined in the embodiments of this disclosure.

This disclosure opens the device verification server as an open platform, so that other payment verification servers can register a biological recognition information-based payment function on this open platform. A device verification server at a device manufacturer's side verifies a user device during the payment function provisioning stage. A payment verification server independently verifies an application during the payment function provisioning stage, and verifies a user's identity during the payment stage. As such, the expansibility of the payment function and the capability for supporting third party applications are improved, the load pressure on the device verification server due to expansion of the payment function is avoided and the problem of increased cost and the security problem due to increase in the number of TAs is solved, while the stability of the payment system is ensured.

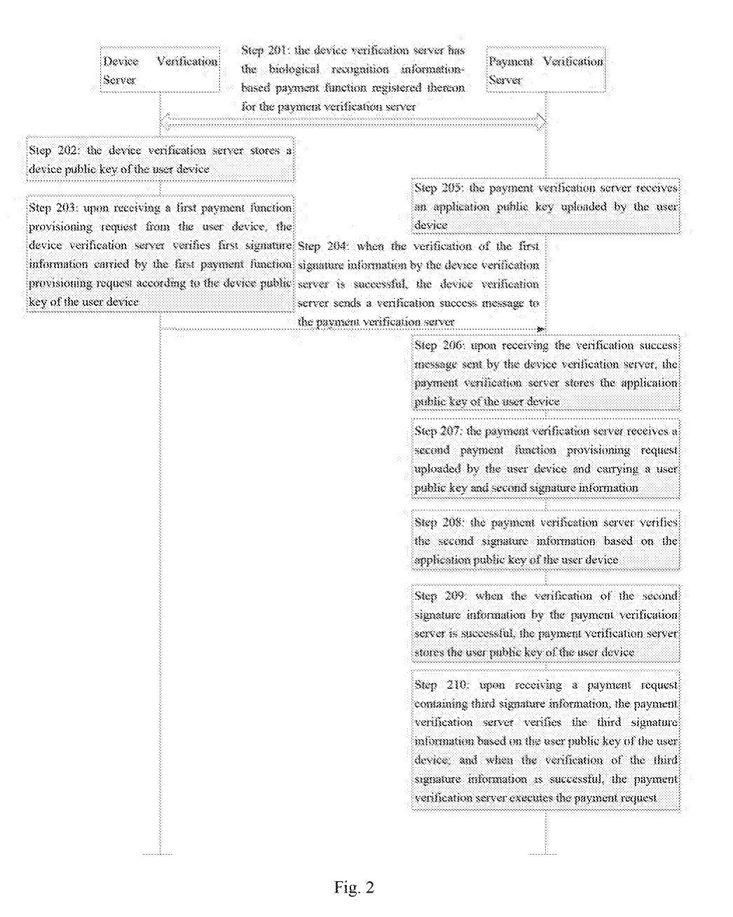

FIG. 2 is a flow chart illustrating interactions in the architecture of the above payment verification system. Referring to FIG. 2, the interaction flow specifically comprises the following steps.

In Step 201, the device verification server has the biological recognition information-based payment function registered thereon for the payment verification server.

A payment application may be registered by an application operator on a device verification server, which may provision the biological recognition information-based payment function, so that a third party's application registered on the device verification server can use the payment function for transactions.

In Step 202, the device verification server stores a device public key of the user device.

The user device has a public key and a private key. The device public key of the user device may be stored in the device verification server before the user device leaves the factory. This pair of keys is closely and uniquely related to the user device and can be used to verify the authenticity of the user device. After the user device leaves the factory, an application key pair and a user key pair may be generated based on a preset algorithm. The application key pair may comprise an application public key and an application private key. The user key pair may comprise a user public key and a user private key. These two pairs of keys may be used to verify the validity of the user's data.

In Step 203, upon receiving a first payment function provisioning request from the user device, the device verification server verifies first signature information carried by the first payment function provisioning request according to the device public key of the user device, wherein the first signature information is obtained by signing specific content by the user device with a device private key of the user device.

The first payment function provisioning request may be sent by the user via a payment application operating on the user device. When the user wants to make a payment using the payment application, the payment function should be activated.

In Step 204, when the verification of the first signature information by the device verification server is successful, the device verification server sends a verification success message to the payment verification server.

The device verification server may decrypt the first signature information using the device private key of the user device. If the decryption of the first signature information is successful, the verification of the first signature information is successful, and it can be determined that the first payment function provisioning request is indeed sent by a legitimate user device. In this case, the payment verification server may be authorized to store the application public key of the user device.

In Step 205, the payment verification server receives an application public key uploaded by the user device.

When the user device sends the first payment function provisioning request, the first payment function provisioning request may also carry the application public key of the user device. Thus, when the payment verification server receives and forwards the first payment function provisioning request, the application public key of the user device may be extracted. Of course, the application public key of the user device may be sent after the user device sends the first payment function provisioning request, which will not be specifically defined in the embodiments of this disclosure.

It should be noted that, in the embodiments of this disclosure, the specific time sequence of the steps is just described by way of example. In actual scenarios, Steps 204 and 205 may be performed according to another time sequence. For example, Step 205 may be performed before Step 204, or Steps 204 and 205 may be performed simultaneously. In other words, so long as Steps 204 and 205 are finished before Step 206, the embodiments of this disclosure will not specifically define the sequence.

In Step 206, upon receiving the verification success message sent by the device verification server, the payment verification server stores the application public key of the user device.

After the verification of the user device by the device verification server is successful, the payment verification server may be informed to store the application public key of the user device, so that the user device may be verified in the subsequent payment process.

As shown by the above steps, through preliminary verification of the user device, the device verification server stores the application public key of the user device in the payment verification server, so that exchange of keys between the device verification server at the device manufacturer's side and the payment verification server at the payment service provider's side is realized, thereby ensuring communication security between the two servers.

In Step 207, the payment verification server receives a second payment function provisioning request uploaded by the user device and carrying a user public key and second signature information, wherein the second signature information is obtained by signing specific content by the user device with an application private key of the user device.

The second payment function provisioning request may be sent after the user device sends the first payment function provisioning request, and does not need to be sent to the device verification server. The second payment function provisioning request is used to apply to the payment verification server for provisioning of the payment function for the user device.

In Step 208, the payment verification server verifies the second signature information based on the application public key of the user device.

In Step 209, when the verification of the second signature information by the payment verification server is successful, the payment verification server stores the user public key of the user device.

After the above verification process, the payment verification server may store the user public key of the user device, so that the subsequent payment process may be verified using the user public key of the user device.

In Step 210, upon receiving a payment request carrying third signature information, the payment verification server verifies the third signature information based on the user public key of the user device; and when the verification of the third signature information is successful the payment verification server executes the payment request.

Through the above process, the device verification server at the device manufacturer's side does not need to be engaged in the payment process. Instead, the payment client on the user device sends a payment request; alter verification of the biological recognition information is successful the user device signs specific content using a user private key. After the payment verification server at the payment service provider's side receives the payment request, verification of the third signature information is performed based on the user public key. If verification of the third signature information is successful, it is believed that the user's identity has been approved, and the payment request can be executed to complete the payment process.

This disclosure opens the device verification server as an open platform so that other payment verification servers can register a biological recognition information-based payment function on this open platform. A device verification server as a device manufacturers side verifies a user device during the payment function provisioning stage. A payment verification server independently verifies an application during the payment function provisioning stage, and verifies a user's identity during the payment stage. As such, the expansibility of the payment function and the capability for supporting third party applications are improved, the load pressure on the device verification server due to expansion of the payment function is avoided, and the problem of increased cost and the security problem due to increase in the number of TAs is solved, while the stability of the payment system is ensured. The system architecture provided by this disclosure effectively standardizes the fingerprint payment service procedure, expands at the service provider the support of payment applications by the user device such as cell phones and effectively reduces the pressure on the background servers of device manufacturers. The device verification server at the uppermost layer in the system architecture can guarantee the service stability, improves the concurrent capability and ensures the stability of interactions among servers.

Alternative embodiments can be made from any combination of the above optional technical solutions, and the descriptions thereof are omitted here.

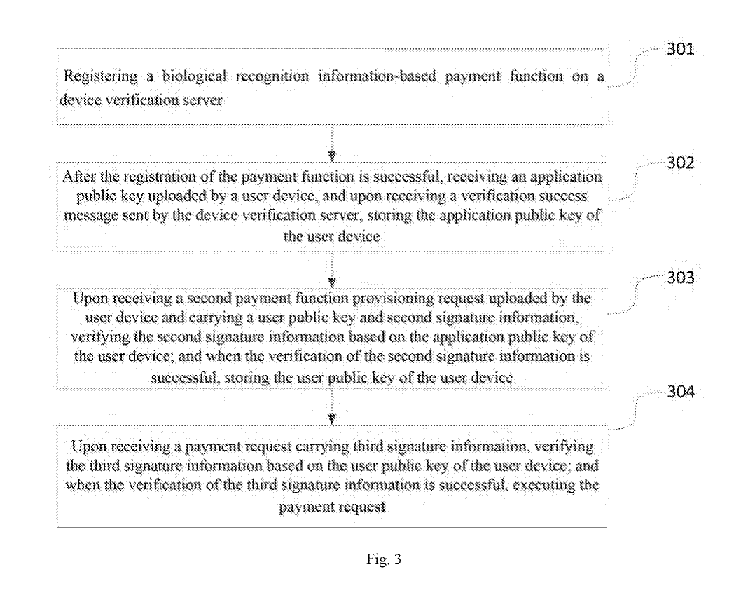

FIG. 3 is a flow chart showing a payment verification method according to an exemplary embodiment. As shown in FIG. 3, the method comprises:

Step 301: registering a biological recognition information-based payment function on a device verification server.

Step 302: after the registration of the payment function is successful, receiving an application public key uploaded by a user device, and upon receiving a verification success message sent by the device verification server, storing the application public key of the user device.

Step 303: upon receiving a second payment function provisioning request uploaded by the user device and carrying a user public key and second signature information, verifying the second signature information based on the application public key of the user device; and when the verification of the second signature information is successful, storing the user public key of the user device, wherein the second signature information is obtained by signing specific content by the user device with an application private key of the user device.

Step 304: upon receiving a payment request carrying third signature information, verifying the third signature information based on the user public key of the user device; and when the verification of the third signature information is successful, executing the payment request, wherein the third signature information is obtained by signing specific content by the user device with a user private key of the user device.

It should be noted that, in the embodiments of this disclosure, the specific content may be transaction information, user information or the like, which will not be specifically defined in the embodiments of this disclosure. The specific content used as the signature object for each time may be the same or may vary according to different procedures and different algorithms, which will not be specifically defined in the embodiments of this disclosure.

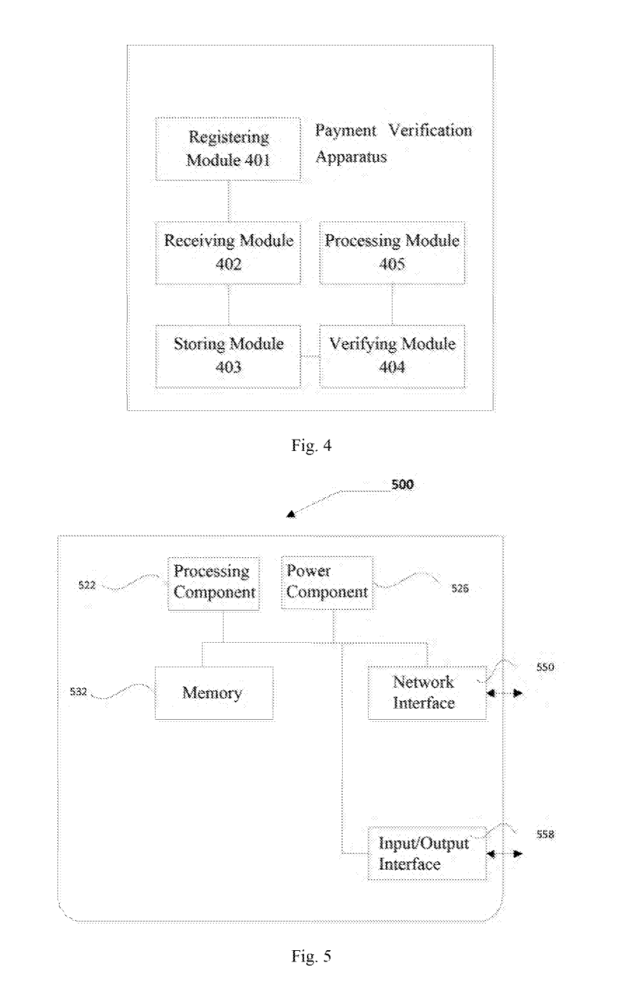

FIG. 4 is a block diagram of a payment verification apparatus according to an exemplary embodiment. As shown in FIG. 4. the apparatus comprises: a registering module 401, a receiving module 402, a storing module 403, a verifying module 404 and a processing module 405.

The registering module 401 is configured to register a biological recognition information-based payment function on a device verification server.

The receiving module 402 is configured to, after the registration of the payment function is successful, receive an application public key uploaded by a user device.

The storing module 403 is configured to, when a verification success message sent by the device verification server is received, store the application public key of the user device.

The verifying module 404 is configured to: when a second payment function provisioning request uploaded by the user device and carrying a user public key and second signature information is received, verify the second signature information based on the application public key of the user device; and when the verification of the second signature information is successful, trigger the storing module to store the user public key of the user device, wherein the second signature information is obtained by signing specific content by the user device with an application private key of the user device.

The verifying module 404 is also configured to: when a payment request carrying third signature information is received, verity the third signature information based on the user public key of the user device.

The processing module 405 is configured to: when the verification of the third signature information is successful, execute the payment request, wherein the third signature information is obtained by signing specific content by the user device with a user private key of the user device.

With respect to the apparatus in the above embodiments, the specific manners for performing operations for individual modules therein have been described in detail in the embodiments regarding the steps of the play control method, and will not be elaborated herein.

FIG. 5 is a block diagram of a payment verification apparatus 500 according to an exemplary embodiment. For example, the apparatus 500 may be provided as a server. As shown in FIG. 5, the apparatus 500 comprises: a processing component 522 which further comprises one or more processors; and memory resources represented by a memory 532 for storing instructions executable by the processing component 522, such as applications. The applications stored in the memory 532 may comprise one or more modules, each module corresponding to a group of instructions. In addition, the processing component 522 is configured to execute instructions to perform the above payment verification method.

The apparatus 500 may further comprise a power component 520 configured to perform power management for the apparatus 500, a wired or wireless network interface 550 configured to connect the apparatus 500 to a network, and an input/output I/O interface 558. The apparatus 500 may operate an operating system stored in the memory 532, such as Windows Server™, Mac OS X™, Unix™, Linux™, FreeBSD™ or the like.

It is noted that the various modules, sub-modules, units and components in the present disclosure can be implemented using any suitable technology. In an example, a module can be implemented using circuitry, such as integrated circuit (IC). In another example, a module can be implemented as a processing circuit executing software instructions.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

1. A system for payment verification, comprising a device verification server and at least one payment verification server, wherein:
the device verification server is configured to register the at least one payment verification server to provide a payment service that is based on biometric recognition, and verify a user device in response to a request from the user device to the at least one payment verification server to activate a payment function that is based on biometric recognition; and
the payment verification server is configured to verify a payment application that is used on the user device in response to the request from the user device to activate the payment function when the user device is verified with success, activate the user device for the payment function, when the payment application is verified with success, and verify one or more payment requests from the user device.

2. The system according to claim 1, wherein the device verification server is configured to:
store a device public key of the user device that pairs with a device private key of the user device;
receive first signature information carried in a first message associated with the request from the user device to activate the payment function, the first signature information being generated based on the device private key of the user device;
verify the first signature information using the device public key of the user device; and
when the verification of the first signature information is successful, send a verification success message to die payment verification server.

3. The system according to claim 2, wherein
the payment verification server is configured to:
store an application public key uploaded by the user device when the verification success message is received from the device verification server, the application pubic key being paired with an application private key of the user device;
receive second signature information carried in a second message associated with the request from the user device to activate the payment function, the second message carrying a user public key and the second signature information that is generated based on the application private key;
verify the second signature information based on the application public key; and
store the user public key when the second signature information is verified with success.

4. The system according to claim 3, wherein the payment verification server is configured to:
receive third signature information carried in a third message associated with a payment request from the user device, the third signature information being generated based on a user private key that pairs with the user public key;
verify the third signature information based on the user public key of the user device; and
when the verification of the third signature information is successful, execute the payment request.

5. The system according to claim 1, wherein the system further comprises a payment server configured to perform message transmission between the user device and the payment verification server.

6. A method for payment verification, comprising:
registering at least one payment verification server on a device verification server to provide a payment service that is based on biometric recognition to users;
verifying, by die device verification server a user device in response to a request from the user device to the payment verification server to activate a payment function that is based on biometric recognition;
verifying, by the payment verification server, a payment application that is used on the user device in response to the request from the user device when the user device is verified with success;
activating, by the payment verification server, the payment function for the user device when the payment application is verified with success, and
verifying, by the payment verification server one or more payment requests from the user device.

7. The method according to claim 6, wherein verifying, by the device verification server, the user device in response to the request from the user device to the payment verification server to activate the payment function that is based on biometric recognition comprises:
storing, at the device verification server, a device public key of the user device that pairs with a device private key of the user device;
receiving, at the device verification, server, first signature information carried in a first message associated with the request from the user device to activate the payment function, the first signature information being generated based on the device private key of the user device;
verifying, by the device verification server, the first signature information using the device public key of the user device; and
sending a verification success message to the payment verification server when the first signature information is verified with success.

8. The method according to claim 7, further comprising:
storing, at the payment verification server, an application public key uploaded by the user device when the verification success message is received from the device verification server, the application pubic key being paired with an application private key of the user device;
receiving at the payment verification server, second signature information carried in a second message associated with the request from the user device to activate the payment function, the second message carrying a user public key and the second signature information that is generated based on the application private key;
verifying, by the payment verification server, the second signature information based on the application public key; and
storing the user public key at the payment verification server when the second signature information is verified with success.

9. The method according to claim 8, wherein verifying, by the payment verification server one or more payment requests from the user device comprises:
receiving, at the payment verification server, third signature information carried in a third message associated with a payment request from the user device, the third signature information being generated based on a user private key that pairs with the user public key;
verifying the third signature information based on the user public key of the user device; and
executing the payment request when the third signature information is verified with success.

10. The method according to claim 6, further comprising:
transmitting, by a payment server, messages between the user device and the payment verification sewer.

11. A payment verification apparatus, comprising:
a processor; and
a memory storing an instruction executable by the processor,
wherein the processor is configured to:
receive a request from a user device to activate a payment function based on biometric recognition;
send the request to a device verification server for the device verification server to verify the user device, the payment verification apparatus being registered on the device verification server to provide a payment service that is based on biometric recognition;
verify a payment application that is used on the user device in response to the request when the user device is verified with success by the device verification server;
activate the payment function for the user device when the payment application is verified with success; and
verify one or more payment requests from the user device.

12. The payment verification apparatus according to claim 11, wherein the processor is configured to:
send first signature information carried in a first message associated with the request from the user device, the first signature information being generated by the user device based on a device private key of the user device, and the device verification server storing a device public key of the user device that pairs with the device private key of the user device; and
receive a verification success message when the first signature information is verified with success by the device verification server based on the device public key of the user device.

13. The payment verification apparatus according to claim 12, wherein the processor is configured to:
store an application public key uploaded by the user device to the memory when the verification success message is received from the device verification server, the application pubic key being paired with an application private key of the user device;
receive second signature information carried in a second message associated with the request from the user device to activate the payment function, the second message carrying a user public key and the second signature information that is generated based on the application private key;
verify the second signature information based on the application public key, and
store the user public key to the memory when the second signature information is verified with success.

14. The payment verification apparatus according to claim 13, wherein the processor is configured to:
receive third signature information carried in a third message associated with a payment request from the user device, the third signature information being generated based on a user private key that pairs with the user public key;
verify the third signature information based on the user public key of the user device; and
when the verification of the third signature information is successful, execute the payment request.
